(19) United States
(12) Patent Application Publication
(10) Pub. No.: US 2012/0046064 A1
(43) Pub. Date: Feb. 23, 2012

(54) Method and Arrangement in a Wireless Telecommunications System

(75) Inventors: Robert Baldemair, Solna (SE); Ylva Jading, Stockholm (SE); Ghyslain Pelletier, Boden (SE)

(73) Assignee: TELEFONAKTIEBOLAGET LM ERICSSON (PUBL), Stockholm (SE)

(21) Appl. No.: 13/318,091

(22) PCT Filed: Sep. 30, 2009
(86) PCT No.: PCT/EP2009/062700

§ 371 Date: Oct. 28, 2011

Related U.S. Application Data
(60) Provisional application No. 61/174,220, filed on Apr. 30, 2009.

(51) Int. Cl. H04W 52/04; H04B 7/24

(52) U.S. Cl. 455/522

(57) ABSTRACT

A method in a base station for deriving a power headroom for a first component carrier is provided. The base station is a radio base station and is comprised in a wireless communication system. The base station is configured to use carrier aggregation comprising a first component carrier and a second component carrier. The base station receives (301) a power headroom report from a user equipment. The power headroom report comprises power headroom information for the second component carrier. The base station also establishes (302) the pathloss relationship between the first component carrier and the second component carrier. The base station then derives (303) the power headroom for the first component carrier based on the received power headroom information and the established pathloss relationship between the first component carrier 1 and the second component carrier.

### TECHNICAL FIELD

The present invention relates to a method and an arrangement in a base station and a method and an arrangement in a user equipment. In particular, it relates to deriving a power headroom for a component carrier and assisting in deriving a power headroom for a component carrier.

### BACKGROUND

In a typical cellular radio system, also referred to as a wireless communication system, wireless terminals, also known as mobile terminals and/or User Equipments (UEs) communicate via a Radio Access Network (RAN) to one or more core networks. The wireless terminals can be mobile stations or user equipment units such as mobile telephones also known as “cellular” telephones, and laptops with wireless capability, e.g., mobile termination, and thus can be, for example, portable, pocket, hand-held, computer-included, or car-mounted mobile devices which communicate voice and/or data with radio access network.

The radio access network covers a geographical area which is divided into cell areas, with each cell area being served by a base station, e.g., a Radio Base Station (RBS), which in some networks is also called “eNB”, “NodeB” or “B node” and which in this document also is referred to as a base station. A cell is a geographical area where radio coverage is provided by the radio base station equipment at a base station site. The base stations communicate over the air interface operating on radio frequencies with the user equipment units within range of the base stations.

In some versions of the radio access network, several base stations are typically connected, e.g., by landlines or microwave, to a Radio Network Controller (RNC). The radio network controller, also sometimes termed a Base Station Controller (BSC), supervises and coordinates various activities of the plural base stations connected thereto. The radio network controllers are typically connected to one or more core networks.

The Universal Mobile Telecommunications System (UMTS) is a third generation mobile communication system, which evolved from the Global System for Mobile Communications (GSM), and is intended to provide improved mobile communication services based on Wideband Code Division Multiple Access (WCDMA) access technology. UMTS Terrestrial Radio Access Network (UTRAN) is essentially a radio access network using wideband code division multiple access for user equipment units (UEs). The Third Generation Partnership Project (3GPP) has undertaken to evolve further the UTRAN and GSM based radio access network technologies.

The LTE Release 8 (Rel-8) standard has recently been standardized, supporting bandwidths up to 20 MHz. However, in order to meet the upcoming International Mobile Telecommunication (IMT)-Advanced requirements, 3GPP has initiated work on LTE-Advanced. One of the parts of LTE-Advanced is to support bandwidths larger than 20 MHz. One important requirement on LTE-Advanced is to assure backward compatibility with LTE Rel-8. This should also include spectrum compatibility. That would imply that an LTE-Advanced carrier, wider than 20 MHz, should appear as a number of LTE carriers to an LTE Rel-8 user equipment. Each such carrier may be referred to as a component carrier. In particular for early LTE-Advanced deployments it can be expected that there will be a smaller number of LTE-Advanced-capable user equipments compared to many LTE legacy user equipments. Therefore, it is necessary to assure an efficient use of a wide carrier also for legacy user equipments, i.e. that it is possible to implement carriers where legacy user equipments can be scheduled in all parts of the wideband LTE-Advanced carrier. The straightforward way to obtain this would be by means of carrier aggregation. Carrier aggregation implies that an LTE-Advanced user equipment can receive multiple component carriers, where the component carriers have, or at least the possibility to have, the same structure as a Rel-8 carrier.

The number of aggregated component carriers as well as the bandwidth of the individual component carrier may be different for Uplink (UL) and Downlink (DL). A symmetric configuration refers to the case where the number of component carriers in DL and UL is the same whereas an asymmetric configuration refers to the case that the number of component carriers is different. It is important to note that the number of component carriers configured in a cell may be different from the number of component carriers seen by a user equipment: A user equipment may for example support more DL component carriers than UL component carriers, even though the cell is configured with the same number of UL and DL component carriers.

Uplink Power Control in LTE

The set of layer 1 functions in the base station includes power control and link adaptation. Layer 1 is also referred to as the Physical Layer. The Physical Layer comprises the basic hardware transmission technologies of a network.

The power control mechanism aims to keep the received Signal-to-Noise Ratio SNR, or Signal-to-Noise and Interference Ratio SINR if interference is accounted for, at a targeted value SNR target. Uplink power control is used both on the Physical Uplink Shared CHannel (PUSCH) and on the Physical Uplink Control CHannel (PUCCH). In both cases, a parameterized open loop combined with a closed loop mechanism is used. The base station uses the Physical Downlink Control Channel (PDCCH) to transmit Transmit Power Control (TPC) command scrambled using TPC-PUSCH-RNTI and TPC-PUCCH-RNTI respectively. (Radio Network Temporary Identifier (RNTI))

The uplink link adaptation consists in the selection of modulation and channel coding, which is controlled by the network. The base station measures the uplink channel quality and orders the UE to use a specific Modulation and Coding Scheme (MCS) based on this. Other parameters may also be taken into account, such as UE power headroom (PH), scheduled bandwidth, buffer content and acceptable delay. The link adaptation function determines the transmission parameters (MCS), allocated bandwidth, and possibly MIMO related parameters based on an estimated SNR, or SINR if interference is estimated.

To perform these functions, the base station needs knowledge of the uplink gain of the UE to the base station. To achieve this knowledge, the base station must know the received power from the UE as well as the transmit power of the UE. Knowledge of the former can be obtained by measuring on the uplink transmission, however the UE transmit power is known only if the UE reports the transmit power to the base station.

Power Headroom Reporting

In LTE Rel-8, the UE measures the power headroom. The power headroom is a measure of the difference between the configured UE maximum power (Pmax) and the UE transmit power, in dB, which is calculated based on the nominal received power per resource block used on PUSCH, the number of scheduled resource blocks and the estimated pathloss. The value calculated is tied to the subframe in which the transmission of the report is performed. In LTE and LTE-A the time is divided into frames of 10 ms and each frame is divided into 10 subframes of length 1 ms. Scheduling is based on subframes, i.e. a smallest resources a terminal can get assigned is 1 subframe in time.

Power headroom reports (PHR) may be transmitted together with data as MAC control elements. Transmission of a PHR is triggered when the path loss measured by the UE has changed by more than a certain value since the last transmission of a PHR (unless the prohibit timer is running). It can also be transmitted periodically, if configured by the network.

PHR triggers have been specified to minimize the overhead of the transmission, so that reports are sent by the UE to the base station only when necessary.

Carrier aggregation is a new technology component introduced in LTE-Advanced. So far wireless systems did not apply carrier aggregation but were either traditional Frequency Division Duplex (FDD) systems or Time Division Duplex (TDD) systems.

A problem is that a transmission system typically only had one UL transmitter and thus only PHR for this single UL transmitter was required. With carrier aggregation however the radio base station needs PHR of all component carriers.

### SUMMARY

It is therefore an object of the invention to provide a mechanism for deriving the power headroom for a component carrier.

According to a first aspect of the invention, the object is achieved by a method in a base station for deriving a power headroom for a first component carrier. The base station is a radio base station and is comprised in a wireless communication system. The base station is configured to use carrier aggregation comprising a first component carrier and a second component carrier. The base station receives a power headroom report from a user equipment. The power headroom report comprises power headroom information for the second component carrier. The base station also establishes the pathloss relationship between the first component carrier and the second component carrier. The base station then derives the power headroom for the first component carrier based on the received power headroom information and the established pathloss relationship between the first component carrier 1 and the second component carrier.

According to a second aspect of the invention, the object is achieved by a method in a user equipment for assisting in deriving a power headroom for a first component carrier of the user equipment. The user equipment is served by a base station comprised in a wireless communication system. The user equipment is configured to use carrier aggregation comprising a first component carrier and a second component carrier. The user equipment transmits a power headroom report to the base station. The power headroom report comprises power headroom information for the second component carrier but not power headroom information for the first component carrier. This enables the base station to derive the power headroom for the first component carrier based on the transmitted power headroom information and an established pathloss relationship between the first component carrier and the second component carrier.

According to a third aspect of the invention, the object is achieved by a base station for deriving a power headroom for a first component carrier. The base station is a radio base station is comprised in a wireless communication system. The base station is configured to use carrier aggregation comprising a first component carrier and a second component carrier. The base station comprises a receiving unit configured to receive a power headroom report from a user equipment, which power headroom report comprises power headroom information for the second component carrier, and an establishing unit configured to establish the pathloss relationship between the first component carrier and the second component carrier. The base station further comprises a deriving unit configured to derive the power headroom for the first component carrier based on the received power headroom information and the established pathloss relationship between the first component carrier and the second component carrier.

According to a fourth aspect of the invention, the object is achieved by a user equipment for assisting in deriving a power headroom for a first component carrier 1 of the user equipment. The user equipment is served by a base station comprised in a wireless communication system. The user equipment is configured to use carrier aggregation comprising a first component carrier and a second component carrier. The user equipment comprises a transmitting unit configured to transmit a power headroom report to the base station. The power headroom report comprises power headroom information for the second component carrier but not power headroom information for the first component carrier.

Since, the user equipment sends a power headroom report for the second component carrier but not the first component carrier, and since the base station can establish the pathloss relationship between the first component carrier and the second component carrier, the base station can derive the power headroom for the first component carrier as well, based on the received power headroom information and the established pathloss relationship. The user equipment therefore requires to report power headroom only for one, or a few component carriers, but not all. The component carriers not being reported power headroom, can be derived by the base station.

An advantage with the invention is that because only the power headroom for one or few component carriers is reported, the proposed present solution reduces reporting overhead.

A further advantage with the invention is that the user equipment only needs to measure or calculate power headroom for one or few component carriers, rather than all of them. Reducing the number of carriers for which power headroom needs to be determined and reported simplifies user equipment implementations.

### BRIEF DESCRIPTION OF THE DRAWINGS

The invention is described in more detail with reference to attached drawings illustrating exemplary embodiments of the invention and in which:

FIG. 1 is a schematic block diagram illustrating embodiments of a wireless communication network.

FIG. 2 is a schematic block diagram illustrating carrier aggregation.

FIG. 3 is a combined schematic block diagram and flowchart depicting embodiments of a method.

FIG. 4 is a table depicting impact of carrier frequency and pathloss exponent γ on pathloss.

FIG. 5 is a schematic block diagram illustrating embodiments of a user equipment.

FIG. 6 is a schematic block diagram illustrating embodiments of a base station.

### DETAILED DESCRIPTION

Briefly describe the present solution involves a base station using knowledge of how path loss changes from one component carrier frequency to another component carrier frequency. Based on this knowledge and a power headroom report for one component carrier received from a user equipment, the base station derives the power headroom for the other second component carrier(s) as well. The user equipment therefore reports power headroom only for one, or a few UL component carriers, but not all.

More broadly, for cases where a base station or other wireless communication network entity requires knowledge of the transmit power headroom of a remote user equipment, for each of a number of component carriers, the base station derives the transmit power headroom for a first carrier, based on power headroom information received for a second carrier, and the path loss relationship between the first and second carriers.

For example, for two uplink component carriers, a user equipment reports transmit power headroom for one of the carriers, and the base station derives the transmit power headroom for the other component carrier, based on known or estimated path loss characteristics for the two component carriers. If multiple component carriers are involved, and power headroom is reported for more than one of them, all of the power headroom reports may be used to improve the accuracy of derived estimates of power headroom for those component carriers for which power headroom was not reported.

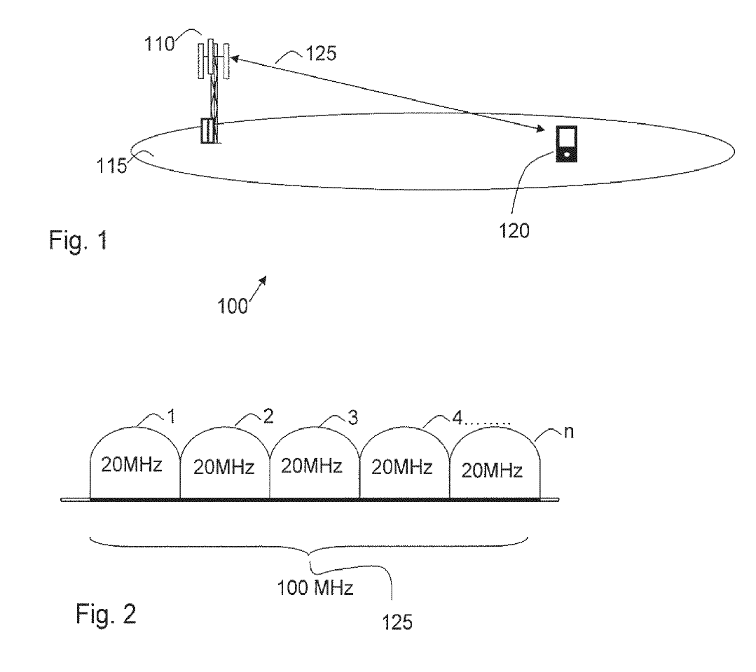

FIG. 1 depicts a wireless communications system 100. The wireless communications system 100 such as an LTE Advanced communications system using LTE Advanced technology, WCDMA-HSPA with dual carrier, IEEE 802.16m or any other wireless communications system configured to use multiple UL transmitters. Therefore, even though the invention is outlined in the context of LTE-Advanced the methods is also applicable to other wireless communications systems with multiple UL transmitters.

The wireless communications system 100 comprises a base station 110 serving a first cell 115. The base station 110 is a radio base station such as an eNB, a Radio Base Station (RBS) or any other network unit capable to communicate over a radio carrier with user equipments being present in the first cell.

A user equipment 120 being present within the first cell 115, is served by the base station 110, and is therefore capable of communicating with the first network node 110 over a radio carrier 125. The user equipment 120 may be a terminal, e.g. a mobile terminal or a wireless terminal, a mobile phone, a computer such as e.g. a laptop, a Personal Digital Assistant (PDA), or any other radio network unit capable to communicate with a base station over a radio carrier. The user equipment 120 may be a legacy user equipment. A legacy user equipment is a user equipment of the same technology family but of an earlier release, e.g. LTE Rel-8 is a legacy technology with respect to LTE Rel-10 (LTE-A).

Carrier Aggregation

To assure an efficient use of a wideband carrier also for legacy user equipments, the base station 110 uses carrier aggregation. Carrier aggregation implies that the wideband carrier is divided into component carriers. In some embodiments, the component carriers have, or at least have the possibility to have, the same structure as a LTE Rel-8 carrier. In this way, e.g. legacy user equipments can be scheduled in a component carrier in all parts of the wideband carrier.

FIG. 2 depicts an example of carrier aggregation wherein the wideband carrier 125 comprises an aggregated bandwidth of 100 MHz, being divided into five component carriers, the first component carrier 1, the second component carrier 2, and a number of third component carriers 3, 4 . . . n, in this example each has a bandwidth of 20M Hz.

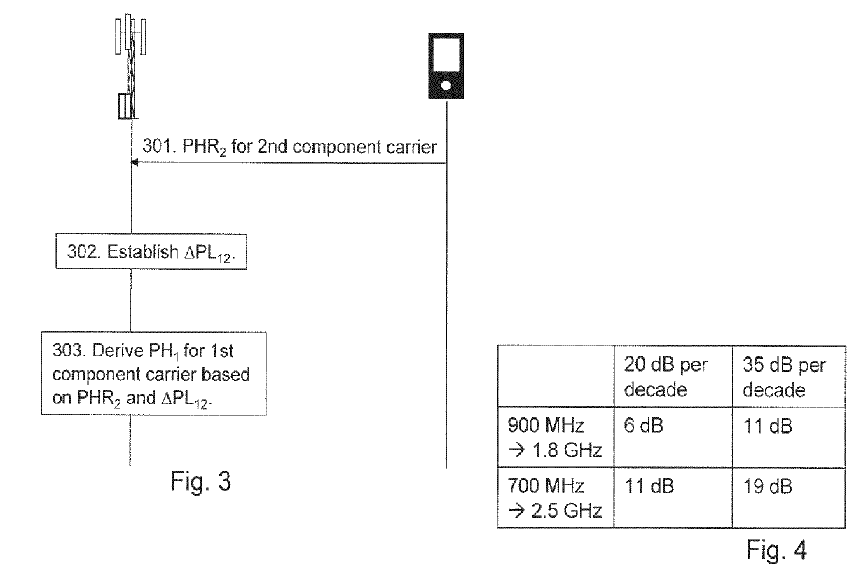

The present solution relating to a method in the base station 110 for deriving a power headroom for the first component carrier 1 according to some embodiments will no be described with reference to the combined signalling diagram and flowchart depicted in FIG. 3. The base station 110 is configured to use carrier aggregation comprising the first component carrier 1 and the second component carrier 2. In some embodiments, the carrier aggregation further comprises a number of third component carriers 3, 4 . . . n as mentioned above. The method comprises the following steps, which steps may as well be carried out in another suitable order than described below:

Step 301

The user equipment 120 transmits a power headroom report to the base station 110. The power headroom report comprises power headroom information for the second component carrier 2 but not any power headroom information for the first component carrier 1. This enables the base station 110 to derive the power headroom for the first component carrier 1 based on the transmitted power headroom information and an established pathless relationship between the first component carrier 1 and the second component carrier 2.

In some embodiments the carrier aggregation further comprises a number of third component carriers 3, 4 . . . n. In these embodiments, this step of transmitting 301, further comprises transmitting a power headroom report to the base station 110 comprising power headroom information for at least one of the respective third component carriers 3, 4 . . . n. This enables the base station 110 to derive the power headroom for the first component carrier 1 further based on the established pathloss relationship between the first component carrier 1 and the at least one respective reported third component carriers 3, 4 . . . n.

The component carriers 2, 3, 4, . . . n that the user equipment 120 has reported power headroom for, are also referred to as “k” in this document, where k can be any of 2, 3, 4, . . . n.

The power headroom report may trigged by an event such as e.g. if the pathloss exceeds a predetermined threshold value.

The transmission of the power headroom report may in some embodiments be performed periodically.

Seeing this step from the base station 110 perspective, the base station 110 receives the power headroom report from the user equipment 120, which power headroom report comprises power headroom information for the second component carrier 2. The power headroom report is referred to as PHR in FIG. 3.

In some embodiments the power headroom report received from the user equipment 120 further comprises power headroom information for at least one of the respective third component carriers 3, 4, . . . n.

In the most general embodiment of the present solution, the base station 110 receives a power headroom report for the second component carrier 2 from the user equipment 120. The base station 110 requires power headroom also for the first component carrier 1, to perform link adaptation and power control on all component carriers. The power headroom for the first component carrier 1 is not reported from the user equipment 120 in any embodiment or example in the present solution. However, in some embodiments power headroom reports may be received by the base station 110 from the user equipment 120 also for the third component carriers 3, 4, . . . n. The base station 110 may then derive (in steps below) power headroom for the first component carrier 1 from any of the second component carrier 2, and/or the third component carriers 3, 4, . . . n, when not being reported from the user equipment 120, by using a received power headroom report from the user equipment 110 regarding any one or more of the second component carrier 2 and/or the third component carriers 3, 4, . . . n.

The user equipment 110 may send the power headroom report for the second component carrier upon request from the base station 110. The reporting may be performed in different ways such as e.g. via a trigger, for example if pathloss changes too much, the user equipment 120 automatically reports power headroom. Other ways are the user equipment 120 may be configured to periodically report power headroom, or the base station 110 explicitly requests a power headroom report from the user equipment 120.

The power headroom in the received report may be calculated by the user equipment 110 using equation (1) below according to the following example. The power headroom is defined as the difference between configured maximum transmit power and the estimated power for PUSCH transmission, expressed in dB.

PH(i)=P_{MAX}−{10 log₁₀(M_{PUSCH}(i))+P_{O}_{_{—}}_{PUSCH}+α·PL+Δ_{TF}(i)+f(i)} [1]

P_{MAX} is the configured maximum transmit power in dBm, M_{PUSCH}(i) is the number of allocated resource blocks. P_{O}_{_{—}}_{PUSCH} is the nominal reception power per resource block at base station 110 in dBm. PL is the pathloss in dB and α controls the power control behavior, Δ_{TF}(i) is a transport format dependent offset in dB. f(i) depends on the transmit power control. The index i is the subframe number and expresses the subframe-dependency.

Step 302

In this step the base station 110 establishes the pathloss relationship between the first component carrier 1 and the second component carrier 2.

In some embodiments, this step further comprises establishing the pathloss relationship between the first component carrier 1 and each of the respective reported third component carriers 3, 4 . . . n.

The base station 110 may establish the pathloss relationship according to the following examples:

The pathloss in a component carrier in dB may be approximated as

PL(dB)=20lg(K)+γlg(f)+βlg(d) [2]

where f is the frequency in Hz, d the distance in m; and γ, β and K are parameters of the equation model. The parameter γ describes the frequency dependency whereas β describes the increase of the pathloss with distance. For free space propagation β is equal to 20 whereas for cellular systems β is often assumed to be between 30 and 40. Values for γ are summarized in the table depicted in FIG. 4, which table relates to impact of carrier frequency and pathloss exponent γ on pathloss, The parameter K describes the path loss at reference frequency (1 Hz) and reference distance (1 m).

The pathloss relationship between the first component carrier 1 and the second component carrier 2 may be represented by ΔPL=PL₂−PL₁, wherein PL₂ is the pathloss in the second component carrier 2 and wherein PL₁ is the pathloss in the first component carrier 1.

In some embodiments wherein power headroom information for a number of third component carriers 3, 4, . . . n are received, the pathloss relationship between the first component carrier 1 and each of the respective reported third component carriers 3, 4, . . . n may be represented by respective ΔPL₁₃=PL₃−PL₁, ΔPL₁₄=PL₄−PL₁, and ΔPL₁ₙ=PLₙ−PL₁. PL₁ denotes the pathloss of the first component carrier 1, PL₂ denotes the pathloss of the second component carrier 2, and each of the PL_{3, 4 . . . n} denotes the pathloss of the respective third component carriers 3, 4, . . . n. In some embodiments, the base station 110 only requires to establish the pathloss difference ΔPL but not the absolute pathloss values.

Using model equation [2] the pathloss difference ΔPL₁₂ between the first component carrier 1 and the second component carrier 2 may be established by using model equation

$$\begin{matrix}Δ {PL}_{12} = {PL}_{2} - {PL}_{1} \\ == 20 lg \frac{{K}_{2}}{{K}_{1}} + lg \frac{{( {f}_{2} )}^{{γ}_{2}}}{{( {f}_{1} )}^{{γ}_{1}}} + lg {d}^{{β}_{2} - {β}_{1}}\end{matrix} \qquad [ {3}_{12} ]$$

Further, the pathloss difference ΔPL₁₃, ΔPL₁₄, ΔPL₁ₙ between the first component carrier 1 and each of the respective third component carrier 3, 4, . . . n may be established by using the same model equation:

$$\begin{matrix}\begin{matrix}Δ {PL}_{13} = {PL}_{3} - {PL}_{1} \\ == 20 lg \frac{{K}_{3}}{{K}_{1}} + lg \frac{{( {f}_{3} )}^{{γ}_{3}}}{{( {f}_{1} )}^{{γ}_{1}}} + lg {d}^{{β}_{3} - {β}_{1}}\end{matrix} \\ or & [ {3}_{13} ] \\ \begin{matrix}Δ {PL}_{14} = {PL}_{4} - {PL}_{1} \\ == 20 lg \frac{{K}_{4}}{{K}_{1}} + lg \frac{{( {f}_{4} )}^{{γ}_{4}}}{{( {f}_{1} )}^{{γ}_{1}}} + lg {d}^{{β}_{4} - {β}_{1}}\end{matrix} \\ or & [ {3}_{14} ] \\ \begin{matrix}Δ {PL}_{14} = {PL}_{4} - {PL}_{1} \\ == 20 lg \frac{{K}_{4}}{{K}_{1}} + lg \frac{{( {f}_{4} )}^{{γ}_{4}}}{{( {f}_{1} )}^{{γ}_{1}}} + lg {d}^{{β}_{4} - {β}_{1}}\end{matrix} & [ {3}_{1 n} ]\end{matrix}$$

where fₖ is the frequency in Hz of component carrier k (k=1, 2, . . . , n), dₖ the distance in meter of component carrier k (k=1, 2, . . . , n), γₖ describes the frequency dependency of component carrier k (k=1, 2, . . . , n), βₖ describes the increase of the pathloss with distance of component carrier k (k=1, 2, . . . , n), and Kₖ is the pathloss at reference frequency and reference distance of the equation model of component carrier k (k=1, 2, . . . , n), [3].

The subscript ₁ denotes the first component carrier 1, the subscript ₂ denotes the second component carrier 2, and the subscript _{3, 4 . . . n} denotes the third component carriers 3, 4 . . . n. The parameters of the propagation models at the different carrier frequencies are typically known from the cell planning. Since d is not known at base station 110 this method requires the same β values across component carriers, i.e. the same β values for the first component carrier 1 and the second component carrier 2.

In some embodiments, where β varies across component carrier frequencies, the example outlined above how to establish ΔPL cannot be used since d is unknown.

In some embodiments an alternative way that may be applied for varying β values is to use model equation [1] to estimate the pathloss at those frequencies where power headroom is reported. This is possible since in [1] all quantities besides the pathloss are known to the base station 110. These one or multiple pathloss estimates may then be used to extrapolate or interpolate the pathloss to non-reported UL component carrier frequencies. Interpolation and extrapolation would be done using model equation [2], i.e. taking the logarithmic dependency of the path loss on the frequency into account. Once the pathloss is known at the non-reported UL frequencies, equation [1] may be used with the parameters for the non-reported UL component carrier frequencies, to calculate the power headroom for non-reported UL component carriers.

In some embodiments one or more pathloss PLₖ for which power headroom are reported are estimated by using the equation:

PHₖ(i)=P_{MAX,k}−{10 log₁₀(M_{PUSCH,k}(i))+P_{O}_{_{—}}_{PUSCH,k}+αₖ·PLₖ+Δ_{TF,k}(i)+fₖ(i)} [1],

for each of the one or more power headroom reported carrier k=2, 3, 4 . . . n, which quantities besides the pathloss PL are known by the base station and which quantities in the equation [1] are component carrier specific.

The one or more pathloss PLₖ k=2, 3, 4 . . . n for which power headroom are reported comprises the pathloss PL_{3, 4 . . . n}, at the frequency of each of the respective third component carriers 3 and/or the pathloss PL₂ at the frequency of the second component carrier 2.

In these embodiments the model equation

PL(dB)=20lg(K)+γlg(f)+βlg(d) [2]

may be used to extrapolate or interpolate the pathloss PL₁ of the first component carrier 1 frequencies from the estimated pathloss PLₖ, k=2, 3, 4 . . . n. In these embodiments the APL is established by ΔPL₁ₖ=PLₖ−PL₁, k=2, 3, 4 . . . n, using the established pathloss PLₖ, k=2, 3, 4 . . . n and the extrapolated or interpolated pathloss PL₁.

In a specific embodiment, model equation [2] is used to calculate the distance d at one or all frequencies where power headroom is reported and thus pathloss is known, since path loss on the reported second carrier may easily be calculated based on the reported power headroom. Since d is the same for all carrier frequencies the multiple estimates may be averaged to improve accuracy. In this example d₂ is calculated for the second component carrier 2 by using model equation

PL₂(dB)=20lg(K₂)+γ₂lg(f₂)+β₂lg(d₂) [2]

also d₃ may be calculated for the third component carriers 3, 4, . . . n in a similar way, with component carrier frequency and model parameters valid at the third component carriers frequency.

d₂=d₁ and d₃=d₁, since d is the same for all carrier frequencies, or d₁ is calculated as the average of d₂ and d₃, thus when d₁ is calculated, pathloss may be derived for the non-reported component carrier 1 by using the calculated d₁ and the equation model

PL₁(dB)=20lg(K₁)+γ₁lg(f₁)+β₁lg(d₁) [2]

where f₁ is here the frequency of the non-reported first component carrier 1 and the other model parameters (β₁, K₁, and γ₁) are the model parameters at the first component carrier frequency and may be the same or may be different for each component carrier.

Accordingly, this means that this specific embodiment may be performed such that the pathloss PLₖ, k=2, 3, 4, . . . , n, is estimated by using the equation:

PHₖ(i)=P_{MAX,k}−{10 log₁₀(M_{PUSCH,k}(i))+P_{O}_{_{—}}_{PUSCH,k}+αₖ·PLₖ+Δ_{TF,k}(i)+fₖ(i)} [1]

for each respective reported power headroom carrier k=2, 3, 4 . . . n. The distance dₖ to the user equipment 120 is calculated by using equation model

PLₖ(dB)=20lg(Kₖ)+γₖlg(fₖ)+βₖlg(d₍ₖ₎) [2]

for the frequencies of each of the at least one power headroom reported carriers k=2, 3, 4, . . . , n, [2].

The pathloss PL₁ at the frequency of the first component carrier is estimated using each reported power headroom carrier k=2, 3, 4 . . . n, and by using each of the respective calculated dₖ, being equal to d₁, and the equation model

PL₁(dB)=20lg(K₁)+γ₁lg(f₁)+β₁lg(d₁) [2]

at the frequencies of the first component carrier 1. An average PL₁ may be derived across all estimated PL₁.

If power headroom report is known for multiple component carriers, say on a second third component carrier (2) and a third component carrier (3), the obtained estimates for the distance d may be averaged prior using these distances to calculate the pathloss at the non-reported component carrier frequency. Alternatively the d values obtained from each reported component carrier may be used to obtain multiple estimates of the pathloss at the first component carrier frequency which are then averaged to obtain the final estimate.

According to another specific embodiment, the pathloss PLₖ, k=2, 3, 4, . . . , n, may be estimated by using the equation:

PHₖ(i)=P_{MAX,k}−{10 log₁₀(M_{PUSCH,k}(i))+P_{O}_{_{—}}_{PUSCH,k}+αₖ·PLₖ+Δ_{TF,k}(i)+fₖ(i)} [1],

for each respective reported power headroom carrier (k=2, 3, 4 . . . n). The distance dₖ to the user equipment 120 is calculated by using equation model

PLₖ(dB)=20lg(Kₖ)+γₖlg(fₖ)+βₖlg(dₖ) [2],

for the frequencies of each of the at least one power headroom reported carriers k=2, 3, 4, . . . , n. In this embodiment, an average d₁ is derived across all calculated dₖ. The pathloss PL₁ at the frequency of the first component carrier is then estimated using the average d₁, and the equation model

PL₁(dB)=20lg(K₁)+γ₁lg(f₁)+β₁lg(d₁) [2]

Step 303

In this step the base station 110 derives the power headroom for the first component carrier 1 based on the received power headroom information and the established pathloss relationship between the first component carrier 1 and the second component carrier 2.

In some embodiments this step of deriving 303 the power headroom for the first component carrier 1 further is based on the established pathloss relationship between the first component carrier 1 and each of the reported respective third component carriers 3, 4 . . . n.

This step may be performed as follows:

In this case, comprising multiple component carriers, potentially all of the parameters in equation (1) may be component carrier specific. According to the present solution, the power headroom difference between two component carriers may be expressed as:

$$\begin{matrix}Δ PH ( i ) = {PH}^{( 2 )} ( i ) - {PH}^{( 1 )} ( i ) = \\ = \{ {P}_{MAX}^{( 2 )} - {P}_{MAX}^{( 1 )} \} - … \\ \{ 10 {log}_{10} ( {M}_{PUSCH}^{( 2 )} ( i ) ) - 10 {log}_{10} ( {M}_{PUSCH}^{( 1 )} ( i ) ) \} - … \\ \{ {P}_{O\_PUSCH}^{( 2 )} - {P}_{O\_PUSCH}^{( 1 )} \} - … \\ \{ {α}^{( 2 )} \cdot {PL}^{( 2 )} - {α}^{( 1 )} \cdot {PL}^{( 1 )} \} - … \\ \{ {Δ}_{TF}^{( 2 )} ( i ) - {Δ}_{TF}^{( 1 )} ( i ) \} - … \\ \{ {f}^{( 2 )} ( i ) - {f}^{( 1 )} ( i ) \} \\ = \{ {P}_{CONF}^{( 2 )} ( i ) - {P}_{CONF}^{( 1 )} ( i ) \} - … \\ \{ {α}^{( 2 )} \cdot {PL}^{( 2 )} - {α}^{( 1 )} \cdot {PL}^{( 1 )} \}\end{matrix} \qquad [ 4 ]$$

The subscripts ₁ and ₂ denote first and second component carrier, respectively. Besides the pathloss, all parameters are signalled from the base station 110 to the user equipment 120 and are summarized in the quantities P_{CONF,1} and P_{CONF,2} for the first and second component carrier, respectively. P_{CONF,1} and P_{CONF,2} may easily be calculated at the base station 110. Using

ΔPL=PL⁽²⁾−PL⁽¹⁾

and substituting PL⁽¹⁾ in equation [4], it is obtained for the difference in power headroom

ΔPH(i)={P⁽²⁾_{CONF}(i)−P⁽¹⁾_{CONF}(i)}−{α⁽²⁾·PL⁽²⁾−α⁽¹⁾·(PL⁽²⁾−ΔPL)} [5]

If it furthermore is assumed the same α values for the two component carriers, equation [5] is simplified to

ΔPH(i)={P⁽²⁾_{CONF}(i)−P⁽¹⁾_{CONF}(i)}−α·ΔPL [6]

The base station 110 only requires to use the established pathloss difference ΔPL but not the absolute pathloss values. The expressions [5] and [6] may be evaluated at the base station 110 assuming that ΔPL can be predicted accurately enough. Once ΔPH(i) is known, the PH for the non-reported component carrier may be calculated as

PH₁(i)=PH₂(i)−ΔPH₁ₖ(i). [7]

Hence, this step 303 of deriving the power headroom for the first component carrier 1 “PH₁” based on the received power headroom information and the established pathloss relationship between the first component carrier 1 and the second and/or third component carriers k=2, 3, 4 . . . n may be performed by using model equation

ΔPHₖ(i)={P_{CONF,k}(i)−P_{CONF,1}(i)}−{αₖ·PLₖ−α₁·(PLₖ−ΔPL₁ₖ)} [5]

for any of the power headroom reported carriers (2, 3, 4 . . . or n), and deriving PH₁(i) by using

PH₁(i)=PHₖ(i)−ΔPH₁ₖ(i), (k=2, 3, 4, . . . , n) [7]

If power headroom of more than one UL component carrier is reported, all reported power headroom may be used to improve accuracy of the power headroom to be derived of the non-reported UL component carriers. For example, model equations [5] or [6] and [7] applied to all UL component carriers with reported power headroom deliver multiple estimates for the power headroom of non-reported UL component carriers. These multiple estimates per UL component carrier may be averaged to improve accuracy.

E.g. in some embodiments power headroom information for more than one component carrier 2, 3, 4 . . . n is received. In these embodiments power headroom for the first component carrier 1 PH₁(i) is derived for each received information, and an average PH₁(i) is derived across all derived PH₁(i).

Other algorithms to calculate the pathloss difference or pathloss are envisioned as well.

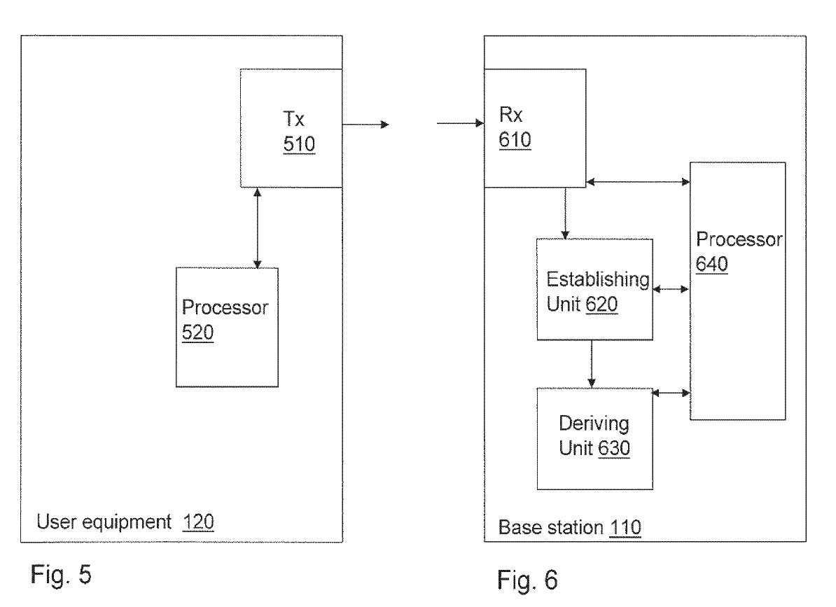

To perform the method steps above within the user equipment 120 for assisting in deriving a power headroom for a first component carrier (1), the user equipment 120 comprises an arrangement depicted in FIG. 5. As mentioned above, the user equipment 120 is served by the base station 110 comprised in the wireless communication system 100. The user equipment 120 is configured to use carrier aggregation comprising the first component carrier 1 and the second component carrier 2.

The user equipment 120 comprises a transmitting unit 510 configured to transmit a power headroom report to the base station 110. The power headroom report comprises power headroom information for the second component carrier 2 but not power headroom information for the first component carrier 1.

In some embodiments the carrier aggregation further comprises a number of third component carriers 3, 4 . . . n. In these embodiments the transmitting unit 510 is further configured to transmit a power headroom report to the base station 110 comprising power headroom information for at least one of the respective third component carriers 3, 4 . . . n.

The transmitting unit 510 may further be configured to transmit the power headroom report trigged by an event such as e.g. if the pathloss exceeds a predetermined threshold value.

The transmitting unit 510 may further be configured to transmit the power headroom report periodically.

To perform the method steps above within the base station 110 for deriving a power headroom for a first component carrier 1, the base station 110 comprises an arrangement depicted in FIG. 6. As mentioned above, the base station 110 is a radio base station and is comprised in the wireless communication system 100. The base station 110 is configured to use carrier aggregation comprising a first component carrier 1 and a second component carrier 2. The carrier aggregation may further comprise a number of third component carriers 3, 4 . . . n.

The base station 110 comprises a receiving unit 610 configured to receive a power headroom report from a user equipment 120. The power headroom report comprises power headroom information for the second component carrier 2.

In some embodiments the receiving unit 610 is further configured to receive a power headroom report from the user equipment 120 comprising power headroom information for at least one of the respective third component carriers 3, 4 . . . n.

The base station 110 further comprises an establishing unit 620 configured to establish the pathloss relationship between the first component carrier 1 and the second component carrier 2.

In some embodiments the establishing unit 620 further is configured to establish the pathloss relationship between the first component carrier 1 and each of the respective reported third component carriers 3, 4 . . . n.

The pathloss PL relationship between the first component carrier 1 and the second component carrier 2 may be represented by ΔPL₁₂=PL₂−PL₁. The pathloss relationship between the first component carrier 1 and each of the respective reported third component carriers 3, 4 . . . n may be represented by respective ΔPL₁₃=PL₃−PL₁, ΔPL₁₄=PL₄−PL₁, and ΔPL₁ₙ=PLₙ−PL₁. PL₁ may denote the pathloss of the first component carrier 1, PL₂ may denote the pathloss of the second component carrier 2, and each of the PL_{3, 4 . . . n} may denote the pathloss of the respective third component carriers 3, 4 . . . n.

The establishing unit 620 may further be configured to establish ΔPL by using

$$\begin{matrix}\begin{matrix}Δ {PL}_{12} = {PL}_{2} - {PL}_{1} \\ == 20 lg \frac{{K}_{2}}{{K}_{1}} + lg \frac{{( {f}_{2} )}^{{γ}_{2}}}{{( {f}_{1} )}^{{γ}_{1}}} + lg {d}^{{β}_{2} - {β}_{1}}\end{matrix} \\ or & [ {3}_{12} ] \\ \begin{matrix}Δ {PL}_{13} = {PL}_{3} - {PL}_{1} \\ == 20 lg \frac{{K}_{3}}{{K}_{1}} + lg \frac{{( {f}_{3} )}^{{γ}_{3}}}{{( {f}_{1} )}^{{γ}_{1}}} + lg {d}^{{β}_{3} - {β}_{1}}\end{matrix} \\ or & [ {3}_{13} ] \\ \begin{matrix}Δ {PL}_{14} = {PL}_{4} - {PL}_{1} \\ == 20 lg \frac{{K}_{4}}{{K}_{1}} + lg \frac{{( {f}_{4} )}^{{γ}_{4}}}{{( {f}_{1} )}^{{γ}_{1}}} + lg {d}^{{β}_{4} - {β}_{1}}\end{matrix} \\ or & [ {3}_{14} ] \\ \begin{matrix}Δ {PL}_{14} = {PL}_{4} - {PL}_{1} \\ == 20 lg \frac{{K}_{4}}{{K}_{1}} + lg \frac{{( {f}_{4} )}^{{γ}_{4}}}{{( {f}_{1} )}^{{γ}_{1}}} + lg {d}^{{β}_{4} - {β}_{1}}\end{matrix} & [ {3}_{1 n} ]\end{matrix}$$

where fₖ is the frequency in Hz of component carrier k, k=1, 2, . . . , n, dₖ the distance in meter of component carrier k, k=1, 2, . . . , n, γₖ describes the frequency dependency of pathloss of component carrier k, k=1, 2, . . . , n, βₖ describes the increase of the pathloss with distance of component carrier k, k=1, 2, . . . , n, and Kₖ is the pathloss at reference frequency and reference distance of the equation model of component carrier k, k=1, 2, . . . , n, [3].

The establishing unit 620 may further be configured to estimate one or more pathloss PLₖ for which power headroom are reported by using the equation:

PHₖ(i)=P_{MAX,k}−{10 log₁₀(M_{PUSCH,k}(i))+P_{O}_{_{—}}_{PUSCH,k}+αₖ·PLₖ+Δ_{TF,k}(i)+fₖ(i)} [1]

for each of the one or more power headroom reported carrier k=2, 3, 4 . . . n. The one or more pathloss PLₖ k=2, 3, 4 . . . n for which power headroom are reported may comprise the pathloss PL_{3, 4 . . . n}, at the frequency of each of the respective third component carriers 3 and/or the pathloss PL₂ at the frequency of the second component carrier 2. The quantities: PHₖ is the power headroom reported by the user equipment 120, P_{MAX} is the configured maximum transmit power in dBm, M_{PUSCH}(i) is the number of allocated resource blocks, P_{O}_{_{—}}_{PUSCH} is the configured reception power per resource block at base station 110 in dBm, α controls the power control behaviour, Δ_{TF}(i) is a transport format dependent offset in dB, f(i) depends on the transmit power control the index i is the subframe number and expresses the subframe-dependency. The quantities in the equation [1] are component carrier specific, and which quantities besides the pathloss PLₖ are known by the base station 110.
The establishing unit 620 may further be configured to use equation

PL(dB)=20lg(K)+γlg(f)+βlg(d) [2]

to extrapolate or interpolate the pathloss FL₁ of the first component carrier 1 frequencies from the estimated pathless PLₖ, k=2, 3, 4, . . . , n.
The establishing unit 620 may further be configured to establish ΔPL is by ΔPL₁ₖ=PLₖ−PL₁, k=2, 3, 4, . . . , n, using the established pathloss PLₖ, k=2, 3, 4, . . . , n and the extrapolated or interpolated pathloss PL₁.

In some embodiments, the establishing unit 620 is further configured to estimate the pathloss PLₖ, k=2, 3, 4, . . . , n, by using the equation:

PHₖ(i)=P_{MAX,k}−{10 log₁₀(M_{PUSCH,k}(i))+P_{O}_{_{—}}_{PUSCH,k}+αₖ·PLₖ+Δ_{TF,k}(i)+fₖ(i)} [1],

for each respective reported power headroom carrier k=2, 3, 4 . . . n. In these embodiments, the establishing unit 620 may further be configured to calculate the distance dₖ to the user equipment 120 by using equation model

PLₖ(dB)=20lg(Kₖ)+γₖlg(fₖ)+βₖlg(d₍ₖ₎) [2]

for the frequencies of each of the at least one power headroom reported carriers k=2, 3, 4, . . . , n, [2]. In these embodiments, the establishing unit 620 further is configured to estimate the pathless PL₁ at the frequency of the first component carrier for each reported power headroom carrier k=2, 3, 4, . . . , n, by using each of the respective calculated dₖ, being equal to d₁, and the equation model

PL₁(dB)=20lg(K₁)+γ₁lg(f₁)+β₁lg(d₁) [2]

at the frequencies of the first component carrier 1. The establishing unit 620 in these embodiments may further be configured to derive an average PL₁ across all estimated PL₁.

In some other embodiments, the establishing unit 620 further is configured to estimate the pathloss PLₖ, k=2, 3, 4, . . . , n, by using the equation:

PHₖ(i)=P_{MAX,k}−{10 log₁₀(M_{PUSCH,k}(i))+P_{O}_{_{—}}_{PUSCH,k}+αₖ·PLₖ+Δ_{TF,k}(i)+fₖ(i)} [1],

for each respective reported power headroom carrier k=2, 3, 4 . . . n, In these embodiments, the establishing unit 620 is further configured to calculate the distance dₖ to the user equipment 120 by using equation model

PLₖ(dB)=20lg(Kₖ)+γₖlg(fₖ)+βₖlg(dₖ) [2],

for the frequencies of each of the at least one power headroom reported carriers k=2, 3, 4, . . . , n, [2], wherein an average distance d₁ is derived across all calculated distance dₖ. In these embodiments, the establishing unit 620 further is configured to estimate the pathloss PL₁ at the frequency of the first component carrier by using the average distance d₁, and the equation model

PL₁(dB)=20lg(K₁)+γ₁lg(f₁)+β₁lg(d₁) [2].

The base station 110 further comprises a deriving unit 630 configured to derive the power headroom for the first component carrier 1 based on the received power headroom information and the established pathloss relationship between the first component carrier 1 and the second component carrier 2.

In some embodiments, the deriving unit 630 further is configured to derive the power headroom for the first component carrier 1 based on the established pathloss relationship between the first component carrier 1 and each of the reported respective third component carriers 3, 4 . . . n.

The deriving unit 630 may further be configured to derive the power headroom for the first component carrier 1 “PH₁(i)” based on the received power headroom information and the established pathloss relationship between the first component carrier 1 and the second and/or third component carriers k=2, 3, 4 . . . n, by using model equation

ΔPHₖ(i)={P_{CONF,k}(i)−P_{CONF,1}(i)}−{αₖ·PLₖ−α₁(PLₖ−ΔPL₁ₖ)} [5]

for any of the power headroom reported carriers 2, 3, 4 . . . or n, and deriving PH₁(i) by using

PH₁(i)=PHₖ(i)−ΔPH₁ₖ(i), [7]

k=2, 3, 4, . . . , n.

In some embodiments wherein receiving unit 610 further is configured to receive power headroom information for more than one component carrier 2, 3, 4 . . . n, the deriving unit 630 may further be configured to derive the power headroom for the first component carrier 1 PH₁(i) for each received information, and to derive an average PH₁(i) across all derived PH₁(i).

The present mechanism for deriving a power headroom for the first component carrier 1, may be implemented through one or more processors, such as a processor 640 in the base station 110 depicted in FIG. 6 or such as a processor 520 in user equipment 120 depicted in FIG. 5, together with computer program code for performing the functions of the present solution. The program code mentioned above may also be provided as a computer program product, for instance in the form of a data carrier carrying computer program code for performing the present solution when being loaded into the base station 110 or into the user equipment. One such carrier may be in the form of a CD ROM disc. It is however feasible with other data carriers such as a memory stick. The computer program code can furthermore be provided as pure program code on a server and downloaded to the base station 110 or to the user equipment 120.

When using the word “comprise” or “comprising” it shall be interpreted as non-limiting, i.e. meaning “consist at least of”.

The present invention is not limited to the above described preferred embodiments. Various alternatives, modifications and equivalents may be used. Therefore, the above embodiments should not be taken as limiting the scope of the invention, which is defined by the appending claims.

1-26. (canceled)

27. A method implemented by a radio base station in a wireless communication system for deriving a power headroom for an unreported component carrier that is aggregated with one or more reported component carriers, the method comprising:
receiving a power headroom report from a user equipment that includes power headroom information for each of said reported component carriers;
establishing a pathloss relationship between the unreported component carrier and each of said reported component carriers; and
deriving the power headroom for the unreported component carrier based on the received power headroom information and the one or more established pathloss relationships.

28. The method according to claim 27, wherein the unreported component carrier is aggregated with two or more reported component carriers.

29. The method according to claim 27, wherein said establishing comprises establishing a pathloss (PL) relationship between the unreported component carrier and any given reported component carrier k, for k=2, 3, . . . n , according to ΔPL₁ₖ=PLₖ−PL₁, where PL₁ is the pathloss of the unreported component carrier and PLₖ is the pathloss of the given reported component carrier k.

30. The method according to claim 29, wherein said establishing comprises establishing a pathloss (PL) relationship between the unreported component carrier and any given reported component carrier k, for k=2, 3, . . . n , according to
$$Δ {PL}_{1 k} = {PL}_{k} - {PL}_{1} = 20 lg ( \frac{{K}_{k}}{{K}_{1}} ) + lg ( \frac{{( {f}_{k} )}^{{γ}_{k}}}{{( {f}_{1} )}^{{γ}_{1}}} ) + lg ( {d}^{{β}_{k } - {β}_{1}} ) ,$$
where f₁ and fₖ respectively represent the frequencies in Hz of the unreported component carrier and the given reported component carrier k, d is the distance in meters between the radio base station and the user equipment, γ₁ and γₖ respectively describe the frequency dependency of the pathloss of the unreported component carrier and the given reported component carrier k, β₁ and βₖ respectively describe the increase of the pathloss of the unreported component carrier and the given reported component carrier k with distance d, and K₁ and Kₖ respectively describe the pathloss of the unreported component carrier and the given reported component carrier k at a reference frequency and reference distance.

31. The method according to claim 29, wherein said establishing comprises:
estimating the pathloss PLₖ of each of said reported component carriers k, at the frequency of that component carrier k, according to
$${PH}_{k} ( i ) = {P}_{MAX , k} - \{ \begin{matrix}10 {log}_{10} ( {M}_{PUSCH , k} ( i ) ) + {P}_{O\_PUSCH , k} + {α}_{k} \cdot {PL}_{k} \\ + {}^{Δ} TF , {k}^{( i ) + {f}_{k} ( i )}\end{matrix} \} ,$$
based on reported values of the power headroom PHₖ for the component carrier k and based on obtained component carrier specific values for a configured maximum transmit power P_{MAX} of the user equipment in dBm, a number M_{PUSCH}(i) of allocated resource blocks, and a configured reception power per resource block P_{O}_{_{—}}_{PUSCH} at the radio base station in dBm, wherein α controls power control behaviour, Δ_{TF}(i) is a transport format dependent offset in dB, f(i) depends on transmit power control, and i is an index for a subframe number and expresses subframe-dependency; and
extrapolating or interpolating the pathloss PL₁ of the unreported component carrier from the estimated pathloss PLₖ of said reported component carriers k, according to PL(dB)=20lg(K)+γlg(f)+βlg(d), where f represents the frequency in Hz of a component carrier, d is the distance in meters between the radio base station and the user equipment, γ describe the frequency dependency of the pathloss of a component carrier, β describes the increase of the pathloss of a component carrier with distance d, and K describes the pathloss of a component carrier at a reference frequency and reference distance.

32. The method according to claim 29, wherein said establishing comprises:
estimating the pathloss PLₖ of each of said reported component carriers k, at the frequency of that component carrier k, according to
$${PH}_{k} ( i ) = {P}_{MAX , k} - \{ \begin{matrix}10 {log}_{10} ( {M}_{PUSCH , k} ( i ) ) + {P}_{O\_PUSCH , k} + {α}_{k} \cdot {PL}_{k} \\ + {}^{Δ} TF , {k}^{( i ) + {f}_{k} ( i )}\end{matrix} \} ,$$
based on reported values of the power headroom PHₖ for the component carrier k and based on obtained component carrier specific values for a configured maximum transmit power P_{MAX} of the user equipment in dBm, a number M_{PUSCH}(i) of allocated resource blocks, and a configured reception power per resource block P_{O}_{_{—}}_{PUSCH} at the radio base station in dBm, wherein a controls power control behaviour, Δ_{TF}(i) is a transport format dependent offset in dB, f(i) depends on transmit power control, and i is an index for a subframe number and expresses subframe-dependency;
calculating an estimated distance dₖ between the radio base station and the user equipment based on the pathloss PLₖ estimated for each of the reported component carriers k, according to PLₖ(dB)=20lg(Kₖ)+γₖlg(fₖ)+βₖlg(dₖ), where γₖ describes the frequency dependency of the pathloss PLₖ, βₖ describes the increase of the pathloss PLₖ with distance dₖ, and Kₖ describes the pathloss PLₖ at a reference frequency and reference distance;
obtaining different estimates of the pathloss PL₁ of the unreported component carrier based on the different estimated distances dₖ, by substituting those distances dₖ in for d₁ in PL₁(dB)=20lg(K₁)+γ₁lg(f₁)+β₁lg(d₁), where γ₁ describes the frequency dependency of the pathloss PL₁, β₁ describes the increase of the pathloss PL₁ with distance d₁, and K₁ describes the pathloss PL₁ at a reference frequency and reference distance; and
averaging the different estimates of PL₁ to derive an averaged PL₁ for use in establishing the one or more pathloss relationships.

33. The method according to claim 29, wherein said establishing comprises:
estimating the pathloss PLₖ of each of said reported component carriers k, at the frequency of that component carrier k, according to
$${PH}_{k} ( i ) = {P}_{MAX , k} - \{ \begin{matrix}10 {log}_{10} ( {M}_{PUSCH , k} ( i ) ) + {P}_{O\_PUSCH , k} + {α}_{k} \cdot {PL}_{k} \\ + {}^{Δ} TF , {k}^{( i ) + {f}_{k} ( i )}\end{matrix} \} ,$$
based on reported values of the power headroom PHₖ for the component carrier k and based on obtained component carrier specific values for a configured maximum transmit power P_{MAX} of the user equipment in dBm, a number M_{PUSCH}(i) of allocated resource blocks, and a configured reception power per resource block P_{O}_{_{—}}_{PUSCH} at the radio base station in dBm, wherein a controls power control behaviour, Δ_{TF}(i) is a transport format dependent offset in dB, f(i) depends on transmit power control, and i is an index for a subframe number and expresses subframe-dependency;
calculating an estimated distance dₖ between the radio base station and the user equipment based on the pathloss PLₖ estimated for each of the reported component carriers k, according to PLₖ(dB)=20lg(Kₖ)+γₖlg(fₖ)+βₖlg(dₖ), where γₖ describes the frequency dependency of the pathloss PLₖ, βₖ describes the increase of the pathloss PLₖ with distance dₖ, and Kₖ describes the pathloss PLₖ at a reference frequency and reference distance;
averaging the estimated distances dₖ to derive an averaged distance d₁; and
estimating the pathloss PL₁ of the unreported component carrier based on the average distance d₁, according to PL₁(dB)=20lg(K₁)+γ₁lg(f₁)+β₁lg(d₁), where γ₁ describes the frequency dependency of the pathloss PL₁, β₁ describes the increase of the pathloss PL₁ with distance d₁, and K₁ describes the pathloss PL₁ at a reference frequency and reference distance.

34. The method according to claim 27, wherein said deriving comprises deriving the power headroom PH₁(i) for the first component carrier based on a reported value of the power headroom PHₖ(i) for a given one of the reported component carriers k, according to PH₁(i)=PHₖ(i)−ΔPH₁ₖ(i), where ΔPHₖ(i)={PCONF,k(i)−PCONF,1(i)}−{αₖ·PLₖ−α₁(PLₖ−ΔPL₁ₖ)}, where
$$PCONF , k ( i ) = {P}_{MAX , k} - \{ \begin{matrix}10 {log}_{10} ( {M}_{PUSCH , k} ( i ) ) + {P}_{O\_PUSCH , k} \\ {+}^{Δ} TF , {k}^{( i ) + {f}_{k} ( i )}\end{matrix} \} , \\ PCONF , 1 ( i ) = {P}_{MAX , 1} - \{ \begin{matrix}10 {log}_{10} ( {M}_{PUSCH , 1} ( i ) ) + {P}_{O\_PUSCH , 1} \\ {+}^{Δ} TF , {1}^{( i ) + {f}_{1} ( i )}\end{matrix} \} ,$$
PL₁ and PLₖ respectively represent the pathloss of the unreported component carrier and the given reported component carrier k, α₁ and αₖ respectively control power control behaviour with respect to the unreported component carrier and the given reported component carrier k, ΔPL₁ₖ represents the pathloss relationship established between the unreported component carrier and the given reported component carrier k, P_{MAX} is a configured maximum transmit power of the user equipment in dBm, M_{PUSCH}(i) is a number of allocated resource blocks, P_{O}_{_{—}}_{PUSCH} is a configured reception power per resource block at the radio base station in dBm, a controls power control behaviour, Δ_{TF}(i) is a transport format dependent offset in dB, f(i) depends on transmit power control, and i is an index for a subframe number and expresses subframe-dependency.

35. The method according to claim 27, wherein the unreported component carrier is aggregated with two or more reported component carriers, and wherein said deriving comprises:
deriving different estimates of the power headroom for the unreported component carrier based on different power headrooms for the reported component carriers and different pathloss relationship established with respect to the reported component carriers; and
averaging the different estimates of the power headroom for the unreported component carrier to derive an averaged power headroom for the unreported component carrier.

36. A method implemented by a user equipment in a wireless communication system for assisting a radio base station serving the user equipment to derive a power headroom for a component carrier for which the user equipment does not report power headroom information, the method comprising:
generating a power headroom report to include power headroom information for each of one or more reported component carriers and to exclude power headroom information for an unreported component carrier that is aggregated with those one or more reported component carriers; and
transmitting the power headroom report to the radio base station.

37. The method according to claim 36, wherein said generating comprises generating the power headroom report to include power headroom information for two or more reported component carriers.

38. The method according to claim 36, wherein said generating and transmitting are trigged when a pathloss of a component carrier changes by an amount that exceeds a predetermined threshold value.

39. The method according to claim 36, wherein said generating and transmitting are performed periodically.

40. A radio base station in a wireless communication system configured to derive a power headroom for an unreported component carrier that is aggregated with one or more reported component carriers, the radio base station comprising:
a receiving unit configured to receive a power headroom report from a user equipment that includes power headroom information for each of said reported component carriers;
an establishing unit configured to establish a pathloss relationship between the unreported component carrier and each of said reported component carriers; and
a deriving unit configured to derive the power headroom for the unreported component carrier based on the received power headroom information and the one or more established pathloss relationships.

41. The base station according to claim 40, wherein the unreported component carrier is aggregated with two or more reported component carriers.

42. The base station according to claim 40, wherein said establishing unit is configured to establish a pathloss (PL) relationship between the unreported component carrier and any given reported component carrier k, for k=2, 3, . . . n , according to ΔPL₁ₖ=PLₖ−PL₁, where PL₁ is the pathloss of the unreported component carrier and PLₖ is the pathloss of the given reported component carrier k.

43. The base station according to claim 42, wherein the establishing unit is configured to establish a pathloss (PL) relationship between the unreported component carrier and any given reported component carrier k, for k=2, 3, . . . n, according to
$$Δ {PL}_{1 k} = {PL}_{k} - {PL}_{1} = 20 lg ( \frac{{K}_{k}}{{K}_{1}} ) + lg ( \frac{{( {f}_{k} )}^{{γ}_{k}}}{{( {f}_{1} )}^{{γ}_{1}}} ) + lg ( {d}^{{β}_{k } - {β}_{1}} ) ,$$
where f₁ and fₖ respectively represent the frequencies in Hz of the unreported component carrier and the given reported component carrier k, d is the distance in meters between the radio base station and the user equipment, γ₁ and γₖ respectively describe the frequency dependency of the pathloss of the unreported component carrier and the given reported component carrier k, β₁ and βₖ respectively describe the increase of the pathloss of the unreported component carrier and the given reported component carrier k with distance d, and K₁ and Kₖ respectively describe the pathloss of the unreported component carrier and the given reported component carrier k at a reference frequency and reference distance.

44. The base station according to claim 42, wherein the establishing unit is configured to:
estimate the pathloss PLₖ of each of said reported component carriers k, at the frequency of that component carrier k, according to
$${PH}_{k} ( i ) = {P}_{MAX , k} - \{ \begin{matrix}10 {log}_{10} ( {M}_{PUSCH , k} ( i ) ) + {P}_{O\_PUSCH , k} + {α}_{k} \cdot {PL}_{k} \\ + {}^{Δ} TF , {k}^{( i ) + {f}_{k} ( i )}\end{matrix} \} ,$$
based on reported values of the power headroom PHₖ for the component carrier k and based on obtained component carrier specific values for a configured maximum transmit power P_{MAX} of the user equipment in dBm, a number M_{PUSCH}(i) of allocated resource blocks, and a configured reception power per resource block P_{O}_{_{—}}_{PUSCH} at the radio base station in dBm, wherein α controls power control behaviour, Δ_{TF}(i) is a transport format dependent offset in dB, f(i) depends on transmit power control, and i is an index for a subframe number and expresses subframe-dependency; and
extrapolate or interpolate the pathloss PL₁ of the unreported component carrier from the estimated pathloss PLₖ of said reported component carriers k, according to PL(dB)=20lg(K)+γlg(f)+βlg(d), where f represents the frequency in Hz of a component carrier, d is the distance in meters between the radio base station and the user equipment, γ describe the frequency dependency of the pathloss of a component carrier, β describes the increase of the pathloss of a component carrier with distance d, and K describes the pathloss of a component carrier at a reference frequency and reference distance.

45. The base station according to claim 42, wherein the establishing unit is configured to:
estimate the pathloss PLₖ of each of said reported component carriers k, at the frequency of that component carrier k, according to
$${PH}_{k} ( i ) = {P}_{MAX , k} - \{ \begin{matrix}10 {log}_{10} ( {M}_{PUSCH , k} ( i ) ) + {P}_{O\_PUSCH , k} + {α}_{k} \cdot {PL}_{k} \\ + {}^{Δ} TF , {k}^{( i ) + {f}_{k} ( i )}\end{matrix} \} ,$$
based on reported values of the power headroom PHₖ for the component carrier k and based on obtained component carrier specific values for a configured maximum transmit power P_{MAX} of the user equipment in dBm, a number M_{PUSCH}(i) of allocated resource blocks, and a configured reception power per resource block P_{O}_{_{—}}_{PUSCH} at the radio base station in dBm, wherein α controls power control behaviour, Δ_{TF}(i) is a transport format dependent offset in dB, f(i) depends on transmit power control, and i is an index for a subframe number and expresses subframe-dependency;
calculate an estimated distance dₖ between the radio base station and the user equipment based on the pathloss PLₖ estimated for each of the reported component carriers k, according to PLₖ(dB)=20lg(Kₖ)+γₖlg(fₖ)+βₖlg(dₖ), where γₖ describes the frequency dependency of the pathloss PLₖ, βₖ describes the increase of the pathloss PLₖ with distance dₖ, and Kₖ describes the pathloss PLₖ at a reference frequency and reference distance;
obtain different estimates of the pathloss PL₁ of the unreported component carrier based on the different estimated distances dₖ, by substituting those distances dₖ in for d₁ in PL₁(dB)=20lg(K₁)+γ₁lg(f₁)+β₁lg(d₁), where γ₁ describes the frequency dependency of the pathloss PL₁, β₁ describes the increase of the pathloss PL₁ with distance d₁, and K₁ describes the pathloss PL₁ at a reference frequency and reference distance; and
average the different estimates of PL₁ to derive an averaged PL₁ for use in establishing the one or more pathloss relationships.

46. The base station according to claim 42, wherein the establishing unit is configured to:
estimate the pathloss PLₖ of each of said reported component carriers k, at the frequency of that component carrier k, according to
$${PH}_{k} ( i ) = {P}_{MAX , k} - \{ \begin{matrix}10 {log}_{10} ( {M}_{PUSCH , k} ( i ) ) + {P}_{O\_PUSCH , k} + {α}_{k} \cdot {PL}_{k} \\ + {}^{Δ} TF , {k}^{( i ) + {f}_{k} ( i )}\end{matrix} \} ,$$
based on reported values of the power headroom PHₖ for the component carrier k and based on obtained component carrier specific values for a configured maximum transmit power P_{MAX} of the user equipment in dBm, a number M_{PUSCH}(i) of allocated resource blocks, and a configured reception power per resource block P_{O}_{_{—}}_{PUSCH} at the radio base station in dBm, wherein α controls power control behaviour, Δ_{TF}(i) is a transport format dependent offset in dB, f(i) depends on transmit power control, and i is an index for a subframe number and expresses subframe-dependency;
calculate an estimated distance dₖ between the radio base station and the user equipment based on the pathloss PLₖ estimated for each of the reported component carriers k, according to PLₖ(dB)=20lg(Kₖ)+γₖlg(fₖ)+βₖlg(dₖ), where γₖ describes the frequency dependency of the pathloss PLₖ, βₖ describes the increase of the pathloss PLₖ with distance dₖ, and Kₖ describes the pathloss PLₖ at a reference frequency and reference distance;
average the estimated distances dₖ to derive an averaged distance d₁; and
estimate the pathloss PL₁ of the unreported component carrier based on the average distance d₁, according to PL₁(dB)=20lg(K₁)+γ₁lg(f₁)+β₁lg(d₁), where γ₁ describes the frequency dependency of the pathloss PL₁, β₁ describes the increase of the pathloss PL₁ with distance d₁, and K₁ describes the pathloss PL₁ at a reference frequency and reference distance.

47. The base station according to claim 40, wherein deriving unit is configured to derive the power headroom PH₁(i) for the first component carrier based on a reported value of the power headroom PHₖ(i) for a given one of the reported component carriers k, according to PH₁(i)=PHₖ(i)−ΔPH₁ₖ(i), where ΔPHₖ(i)={PCONF,k(i)−PCONF,1(i)}−{αₖ·PLₖ−α₁(PLₖ−ΔPL₁ₖ)}, where
$$PCONF , k ( i ) = {P}_{MAX , k} - \{ \begin{matrix}10 {log}_{10} ( {M}_{PUSCH , k} ( i ) ) + {P}_{O\_PUSCH , k} \\ {+}^{Δ} TF , {k}^{( i ) + {f}_{k} ( i )}\end{matrix} \} , \\ PCONF , 1 ( i ) = {P}_{MAX , 1} - \{ \begin{matrix}10 {log}_{10} ( {M}_{PUSCH , 1} ( i ) ) + {P}_{O\_PUSCH , 1} \\ {+}^{Δ} TF , {1}^{( i ) + {f}_{1} ( i )}\end{matrix} \} ,$$
PL₁ and PLₖ respectively represent the pathloss of the unreported component carrier and the given reported component carrier k, α₁ and αₖ respectively control power control behaviour with respect to the unreported component carrier and the given reported component carrier k, ΔPL₁ₖ represents the pathloss relationship established between the unreported component carrier and the given reported component carrier k, P_{MAX} is a configured maximum transmit power of the user equipment in dBm, M_{PUSCH}(i) is a number of allocated resource blocks, O_{O}_{_{—}}_{PUSCH} is a configured reception power per resource block at the radio base station in dBm, α controls power control behaviour, Δ_{TF}(i) is a transport format dependent offset in dB, f(i) depends on transmit power control, and i is an index for a subframe number and expresses subframe-dependency.

48. The base station according to claim 40, wherein the unreported component carrier is aggregated with two or more reported component carriers, and wherein the deriving unit is configured to:
derive different estimates of the power headroom for the unreported component carrier based on different power headrooms for the reported component carriers and different pathloss relationship established with respect to the reported component carriers; and
average the different estimates of the power headroom for the unreported component carrier to derive an averaged power headroom for the unreported component carrier.

49. A user equipment in a wireless communication system configured to assist a radio base station serving the user equipment to derive a power headroom for a component carrier for which the user equipment does not report power headroom information, the user equipment comprising:
a processor configured to generate a power headroom report to include power headroom information for each of one or more reported component carriers and to exclude power headroom information for an unreported component carrier that is aggregated with those one or more reported component carriers; and
a transmitter configured to transmit the power headroom report to the radio base station.

50. The user equipment according to claim 49, wherein the processor is configured to generate the power headroom report to include power headroom information for two or more reported component carriers.

51. The user equipment according to claim 49, wherein the processor is configured to generate the power headroom report responsive to a pathloss of a component carrier changing by an amount that exceeds a predetermined threshold value.

52. The user equipment according to claim 49, wherein the processor is configured to generate the power headroom report periodically.
